(19) United States
(12) Patent Application Publication
(10) Pub. No.: US 2026/0156720 A1
(43) Pub. Date: Jun. 4, 2026

(54) INDUCTIVE HEATING

(71) Applicant: Nicoventures Trading Limited, London (GB)

(72) Inventors: Wing Siu NG, London (GB); Juan Esteban Paz JAUREGUI, London (GB); Huihui LONG, London (GB)

(21) Appl. No.: 19/125,221

(22) PCT Filed: Oct. 30, 2023
(86) PCT No.: PCT/EP2023/080284

§ 371 Date: Apr. 28, 2025

(30) Foreign Application Priority Data
Oct. 31, 2022 (GB) 2216109.5

(51) Int. Cl. H05B 6/06; H05B 6/10

(52) U.S. Cl. CPC H05B 6/06; H05B 6/105

(57) ABSTRACT

A method comprising: driving a resonant circuit of an inductive heater at a determined resonant frequency of the resonant circuit in a heating mode of operation, wherein the inductive heater comprises a switching circuit and a resonant circuit and wherein the inductive heater is for heating a susceptor; comparing a current flowing in the inductive heater during the heating mode of operation with a target current; and controlling triggering of a sampling mode of operation based, at least in part, on a difference between the current flowing in the inductive heater and the target current, wherein the determined resonant frequency is updated during the sampling mode of operation.

### CROSS-REFERENCE TO RELATED APPLICATIONS

This present application is a National Phase entry of PCT Application No. PCT/EP 2023/080284, filed 30 Oct. 2023, which claims priority from Great Britain Application No. 2216109.5, filed 31 Oct. 2022, each of which are fully incorporated herein by reference in their entireties.

### FIELD

The present specification relates to inductive heating of a susceptor.

### BACKGROUND

Many inductive heating systems for heating susceptors are known. There remains a need for further developments in this field.

### SUMMARY

In a first aspect, this specification describes a method comprising: driving a resonant circuit of an inductive heater at a determined resonant frequency of the resonant circuit in a heating mode of operation, wherein the inductive heater comprises a switching circuit and a resonant circuit and wherein the inductive heater is for heating a susceptor; comparing a current flowing in the inductive heater during the heating mode of operation with a target current; and controlling triggering of a sampling mode of operation based, at least in part, on a difference between the current flowing in the inductive heater and the target current, wherein the determined resonant frequency is updated during the sampling mode of operation. The current flowing in the inductive heater may comprise a current flowing in the resonant circuit or a current induced in the susceptor.

Controlling triggering of said sampling mode of operation may comprise triggering said sampling mode in the event that the current flowing in the inductive heater differs from the target current by more than a threshold amount.

Controlling triggering of said sampling mode of operation may comprise setting a sampling period based, at least in part, on the difference between the current flowing in the inductive heater and the target current, wherein the sampling period defines an interval between successive sampling modes of operation of the inductive heater. The method may comprise decreasing the sampling mode period if the current flowing in the inductive heater is reduced. Alternatively, or in addition, the method may comprise increasing the sampling mode period if the current flowing in the inductive heater is increased.

Some example embodiments further comprise entering the heating mode of operation on completion of the sampling mode of operation.

The method may further comprise controlling the switching circuit to apply a pulse to the resonant circuit in the sampling mode of operation to generate a pulse response.

The method may further comprise determining a resonant frequency of the pulse response and updating said determined resonant frequency accordingly. Furthermore, the resonant frequency of the pulse response may be determined based on a time period between zero-crossings of the pulse response.

The method may further comprise determining a difference between a temperature of said susceptor and a target temperature of said susceptor and setting a/the sampling period based, at least in part, on said difference, wherein the sampling period defines an interval between successive sampling modes of operation of the inductive heater. The method may further comprise decreasing the sampling period if the difference between the estimated temperature and the target temperature is reduced and/or increasing the sampling period if the difference between the estimated temperature and the target temperature is increased.

In a further aspect, this specification describes a controller for an inductive heater for heating a susceptor (e.g. a susceptor of an aerosol generating device), the controller comprising: a first output for applying pulses to a resonant circuit of the inductive heater in a heating mode of operation, wherein the pulses are applied at a determined resonant frequency of the heater, wherein the inductive heater comprises a switching circuit and a resonant circuit and wherein the inductive heater is for heating a susceptor; and a control module for controlling triggering of a sampling mode of operation based, at least in part, on a difference between a current flowing in the inductive heater and a target current, wherein a determined resonant frequency of the inductive heater is updated during the sampling mode of operation.

In some example embodiments, the control module triggers said sampling mode of operation in the event that the current flowing in the inductive heater differs from the target current by more than a threshold amount.

The control module may be configured to set a sampling period based, at least in part, on the difference between the current flowing in the inductive heater and the target current, wherein the sampling period defines an interval between successive sampling modes of operation of the inductive heater.

The control module may be further configured to determine a difference between a temperature of said susceptor and a target temperature of said susceptor and to set a/the sampling period based, at least in part, on said difference, wherein the sampling period defines an interval between successive sampling modes of operation of the inductive heater.

In a further aspect, this specification describes an apparatus comprising: a resonant circuit comprising an inductive element and a capacitor, wherein the inductive element is for inductively heating a susceptor (e.g. a susceptor of an aerosol generating device); a driving circuit (e.g. a switching circuit, such as an H-bridge circuit) for applying pulses to a resonant circuit of the inductive heater in a heating mode of operation, wherein the pulses are applied at a determined resonant frequency of the heater; and a processor for controlling triggering of a sampling mode of operation based, at least in part, on a difference between a current flowing in the inductive heater and a target current, wherein a determined resonant frequency of the inductive heater is updated during the sampling mode of operation.

In some example embodiments, the control module triggers said sampling mode of operation in the event that the current flowing in the inductive heater differs from the target current by more than a threshold amount.

The control module may be configured to set said sampling period based, at least in part, on the difference between the current flowing in the inductive heater and the target current, wherein the sampling period defines durations an interval between successive sampling modes of operation of the inductive heater. Alternatively, or in addition, the control module may be configured to determine a difference between a temperature of said susceptor and a target temperature of said susceptor and to set a/the sampling period based, at least in part, on said difference, wherein the sampling period defines an interval between successive sampling modes of operation of the inductive heater.

In a further aspect, this specification describes an aerosol provision device comprising an apparatus as described above with reference to the third aspect. The aerosol generating device may be configured to receive a removable article comprising an aerosol generating material. The said aerosol generating material may comprise an aerosol generating substrate and an aerosol forming material. The said removable article may include a susceptor arrangement.

According to another aspect, there is provided an aerosol provision system comprising an aerosol provision device comprising an apparatus as described above with reference to the third aspect, and an article comprising aerosol generating material.

The article may comprise a susceptor.

According to another aspect, there is provided a method of generating aerosol comprising: providing an aerosol provision system as described above, and at least partially inserting the aerosol generating article into the chamber.

In a further aspect, this specification describes a computer program comprising instructions for causing an apparatus to perform (at least) any method as described herein (including the method of the first aspect described above).

In a further aspect, this specification describes a computer-readable medium (such as a non-transitory computer-readable medium) comprising program instructions stored thereon for performing (at least) any method as described herein (including the method of the first aspect described above).

In a further aspect, this specification describes computer-readable instructions which, when executed by a computing apparatus, cause the computing apparatus to perform (at least) any method as described herein (including the method of the first aspect described above).

In another aspect, this specification describes an apparatus comprising: at least one processor; and at least one memory including computer program code which, when executed by the at least one processor, causes the apparatus to perform (at least) any method as described herein (including the method of the first aspect described above).

### BRIEF DESCRIPTION OF THE DRAWINGS

Example embodiments will now be described, by way of example only, with reference to the following schematic drawings, in which:

FIG. 1 is a block diagram of a system in accordance with an example embodiment;

FIGS. 2 to 4 are flow charts showing algorithms in accordance with example embodiments;

FIGS. 5 and 6 are block diagrams of circuits in accordance with example embodiments;

FIG. 7 is a block diagram of a system in accordance with an example embodiment;

FIG. 8 is a flow chart showing an algorithm in accordance with an example embodiment;

FIG. 9 is a plot showing a pulse in accordance with an example embodiment;

FIG. 10 is a plot showing a pulse response in accordance with an example embodiment;

FIGS. 11 to 17 are flow charts showing algorithms in accordance with example embodiments;

FIG. 18 shows a non-combustible aerosol provision system in accordance with an example embodiment;

FIG. 19 is a view of a non-combustible aerosol provision system in accordance with an example embodiment;

FIG. 20 is a view of an article for use with a non-combustible aerosol provision device in accordance with an example embodiment; and

FIG. 21 is a block diagram of a system in accordance with an example embodiment.

### DETAILED DESCRIPTION

As used herein, the term “aerosol delivery device” is intended to encompass systems that deliver a substance to a user, and includes:
non-combustible aerosol provision systems that release compounds from an aerosolisable material without combusting the aerosolisable material, such as electronic cigarettes, tobacco heating products, and hybrid systems to generate aerosol using a combination of aerosolisable materials; and
articles comprising aerosolisable material and configured to be used in one of these non-combustible aerosol provision systems.

According to the present disclosure, a “combustible” aerosol provision system is one where a constituent aerosolisable material of the aerosol provision system (or component thereof) is combusted or burned in order to facilitate delivery to a user.

According to the present disclosure, a “non-combustible” aerosol provision system is one where a constituent aerosolisable material of the aerosol provision system (or component thereof) is not combusted or burned in order to facilitate delivery to a user.

In embodiments described herein, the delivery system is a non-combustible aerosol provision system, such as a powered non-combustible aerosol provision system.

In one embodiment, the non-combustible aerosol provision system is an electronic cigarette, also known as a vaping device or electronic nicotine delivery system (END), although it is noted that the presence of nicotine in the aerosolisable material is not a requirement.

In one embodiment, the non-combustible aerosol provision system is a tobacco heating system, also known as a heat-not-burn system.

In one embodiment, the non-combustible aerosol provision system is a hybrid system to generate aerosol using a combination of aerosolisable materials, one or a plurality of which may be heated. Each of the aerosolisable materials may be, for example, in the form of a solid, liquid or gel and may or may not contain nicotine. In one embodiment, the hybrid system comprises a liquid or gel aerosolisable material and a solid aerosolisable material. The solid aerosolisable material may comprise, for example, tobacco or a non-tobacco product.

Typically, the non-combustible aerosol provision system may comprise a non-combustible aerosol provision device and an article for use with the non-combustible aerosol provision system. However, it is envisaged that articles which themselves comprise a means for powering an aerosol generating component may themselves form the non-combustible aerosol provision system.

In one embodiment, the non-combustible aerosol provision device may comprise a power source and a controller. The power source may be an electric power source or an exothermic power source. In one embodiment, the exothermic power source comprises a carbon substrate which may be energised so as to distribute power in the form of heat to an aerosolisable material or heat transfer material in proximity to the exothermic power source. In one embodiment, the power source, such as an exothermic power source, is provided in the article so as to form the non-combustible aerosol provision.

In one embodiment, the article for use with the non-combustible aerosol provision device may comprise an aerosolisable material, an aerosol generating component, an aerosol generating area, a mouthpiece, and/or an area for receiving aerosolisable material.

In one embodiment, the aerosol generating component is a heater capable of interacting with the aerosolisable material so as to release one or more volatiles from the aerosolisable material to form an aerosol.

In one embodiment, the aerosolisable material may comprise an active material, an aerosol forming material and optionally one or more functional materials. The active material may comprise nicotine (optionally contained in tobacco or a tobacco derivative) or one or more other non-olfactory physiologically active materials. A non-olfactory physiologically active material is a material which is included in the aerosolisable material in order to achieve a physiological response other than olfactory perception. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In some embodiments, the active substance comprises nicotine. In some embodiments, the active substance comprises caffeine, melatonin or vitamin B12. In one embodiment, the active substance is a legally permissible recreational drug.

The aerosol forming material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more functional materials may comprise one or more of flavours, carriers, pH regulators, stabilizers, and/or antioxidants.

In one embodiment, the article for use with the non-combustible aerosol provision device may comprise aerosolisable material or an area for receiving aerosolisable material. In one embodiment, the article for use with the non-combustible aerosol provision device may comprise a mouthpiece. The area for receiving aerosolisable material may be a storage area for storing aerosolisable material. For example, the storage area may be a reservoir. In one embodiment, the area for receiving aerosolisable material may be separate from, or combined with, an aerosol generating area.

Aerosolisable material, which also may be referred to herein as aerosol generating material, is material that is capable of generating aerosol, for example when heated, irradiated or energized in any other way. Aerosolisable material may, for example, be in the form of a solid, liquid or gel which may or may not contain nicotine and/or flavourants.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

The aerosolisable material may be present on a substrate. The substrate may, for example, be or comprise paper, card, paperboard, cardboard, reconstituted aerosolisable material, a plastics material, a ceramic material, a composite material, glass, a metal, or a metal alloy.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material or a material heatable by electrical conduction.

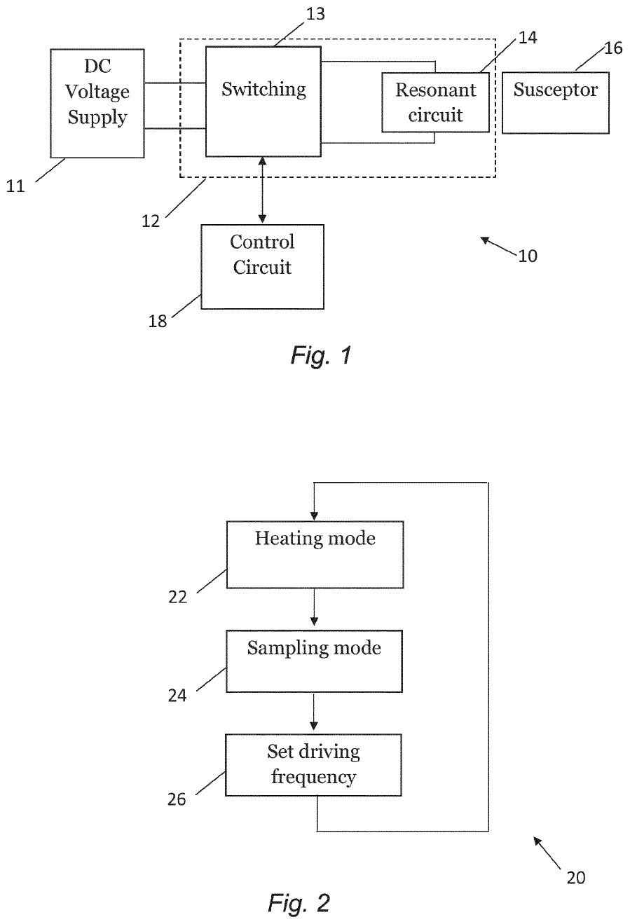

FIG. 1 is a block diagram of a system, indicated generally by the reference numeral 10, in accordance with an example embodiment. The system 10 comprises a power source in the form of a direct current (DC) voltage supply 11, a switching arrangement 13, a resonant circuit 14, a susceptor arrangement 16, and a control circuit 18. The switching arrangement 13 and the resonant circuit 14 may be coupled together in an inductive heating arrangement 12 that can be used to heat the susceptor 16.

As discussed in detail below, the resonant circuit 14 may comprise one or more capacitors and one or more inductive elements for inductively heating the susceptor arrangement 16 to heat an aerosol generating material. Heating the aerosol generating material may thereby generate an aerosol.

The switching arrangement 13 may enable an alternating current to be generated from the DC voltage supply 11 (under the control of the control circuit 18). The alternating current may flow through the one or more inductive elements and may cause the heating of the susceptor arrangement 16. The switching arrangement may comprise a plurality of transistors. Example DC-AC converters include H-bridge or inverter circuits, examples of which are discussed below.

A susceptor is a material that is heatable by penetration with a varying magnetic field, such as an alternating magnetic field. The heating material may be an electrically-conductive material, so that penetration thereof with a varying magnetic field causes induction heating of the heating material, and a thermally conductive material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

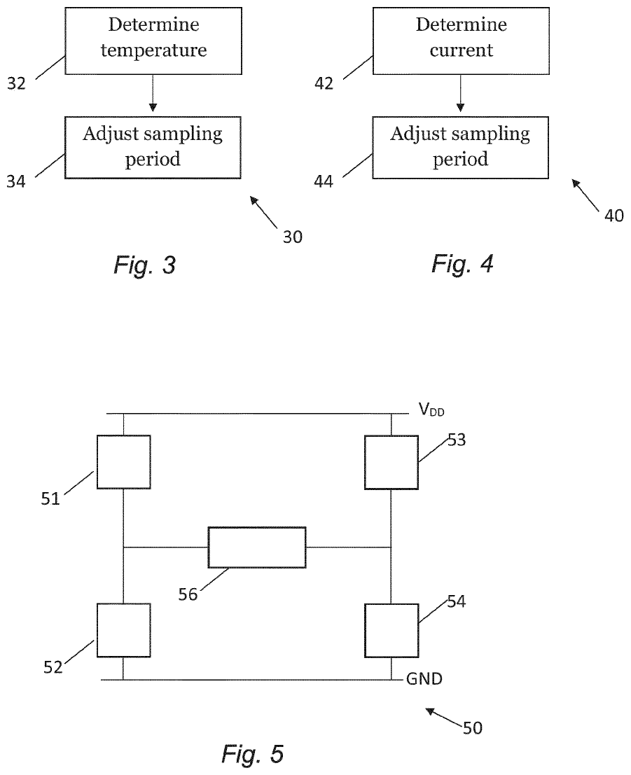

FIG. 2 is a flow chart showing an algorithm, indicated generally by the reference numeral 20, in accordance with an example embodiment. The algorithm 20 may be implemented using the system 10 described above.

The algorithm 20 starts in operation 22, where a resonant circuit (e.g. the resonant circuit 14) is driven at a resonant frequency of the resonant circuit in a heating mode of operation. For example, the switching arrangement 13 may be switched at a determined resonant frequency of the resonant circuit 14 (under the control of the control circuit 18). As discussed further below, the effectiveness of the heating mode 22 may be dependent on the accuracy of the determination of the resonant frequency. The effectiveness of the heating mode 22 may be dependent on the resolution of the output frequency used to drive the resonant circuit.

At operation 24, a sampling mode of operation is entered. The sampling mode may seek to determine the resonant frequency for use in the heating mode (e.g. during the next iteration of the algorithm 20). As discussed in detail below, the sampling mode may include applying a pulse to the resonant circuit at a specified time interval and processing the resonant response to determine/estimate the resonant frequency.

At operation 26, the driving frequency for the resonant circuit is set based on the determined resonant frequency.

Thus, the parameters of the heating mode (including the driving frequency and the sampling interval) are set in the operation 26. The heating of the susceptor occurs in the next iteration of the heating mode 22 until the time interval dictated by the sampling mode occurs. The algorithm 20 then re-enters the sampling mode 24 where the resonant frequency of the resonant circuit is again determined and the parameters of the heating and sampling modes are updated (in the operation 26).

A controller (which may be part of the control circuit 18) may be used to determine how often to initiate the sampling mode 24. The controller may seek to strike a balance between sampling sufficiently often to ensure that the resonant circuit is being driven at (or close to) its resonant frequency in the heating mode 22 (thereby tending to increase heating efficiency) and having a low sampling rate (i.e. a high sampling period) so that the susceptor spends a large proportion of its time being heated (again, tending to increase heating efficiency).

The sampling period (i.e. how often the sampling mode 24 is entered) may be a controllable variable. As discussed in detail below, there are a number of mechanisms that could be used for setting the sampling period (e.g. relating to a heating temperature, heating current, or both).

FIG. 3 is a flow chart showing an algorithm, indicated generally by the reference numeral 30, in accordance with an example embodiment.

The algorithm 30 starts at operation 32, where a temperature of the inductive heater (e.g. the temperature of the susceptor 16) is determined or estimated. At operation 34, the sampling period is adjusted based on the temperature determined in the operation 32.

By way of example, the temperature determined or estimated in the operation 32 may be compared with a target temperature of the susceptor. The sampling period (which may define durations of temperature sampling and heating modes of operation of the inductive heater) set in the operation 34 may be set dependent, at least in part, on that temperature difference. For example, the sampling period may be reduced as the heater temperature approaches the target temperature so that the sampling mode occurs more often when the temperature of the heater is close to the target temperature.

FIG. 4 is a flow chart showing an algorithm, indicated generally by the reference numeral 40, in accordance with an example embodiment.

The algorithm 40 starts at operation 42, where a current flowing in the inductive heater (e.g. in the resonant circuit 14) is determined. At operation 44, the sampling period is adjusted based on the current determined in the operation 42.

By way of example, the current determined in the operation 42 may be compared with a target current (or threshold current). The target current may be at, or close to, a current that might be expected when the resonant circuit is being driven at its resonant frequency. The sampling period set in the operation 44 may be set dependent on that current difference. For example, the sampling period may be increased as the heater current approaches the target current (which may indicate that the resonant circuit is being driven at or close to its resonant frequency) so that the sampling mode occurs less often when the resonant circuit is being drive at close to the resonant frequency.

Reducing the sampling period when the heater current is relatively low can increase heater efficiency by resetting the driving frequency (in an instance of the operation 26) more often. Conversely, if the heater current is high (e.g. at or close to the target current), then the sampling period can be increased so that the driving frequency is updated less often.

In some example embodiments, the temperature of the heater and the current flowing through the heater may both be used in the setting of a sampling period (e.g. the principles of the algorithms 30 and 40 may be combined). For example, the algorithms 30 and 40 may operate in parallel and/or may complement each other.

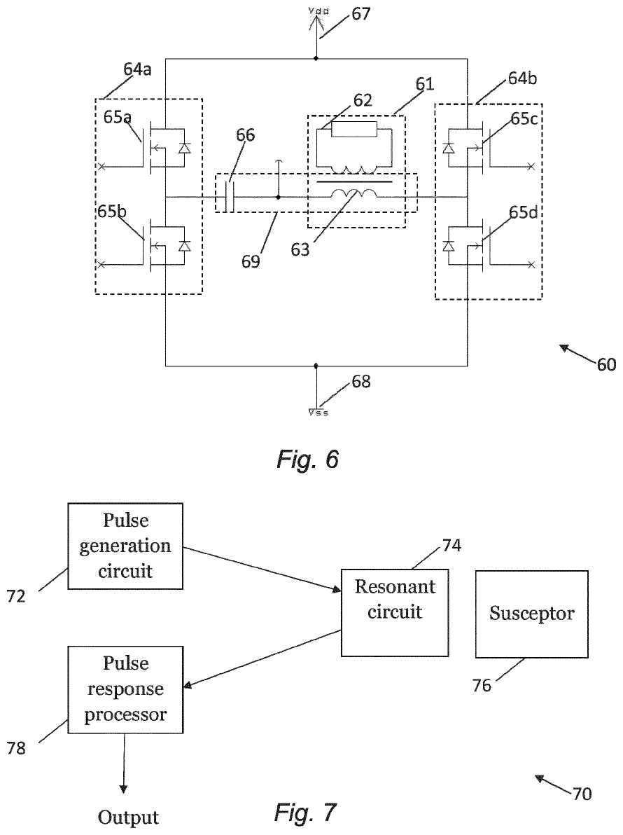

FIG. 5 is a block diagram of a circuit, indicated generally by the reference numeral 50, in accordance with an example embodiment. The circuit 50 comprises a first switch 51, a second switch 52, a third switch 53, a fourth switch 54 and a resonant circuit 56. The first to fourth switches 51 to 54 may be implemented using transistors, as discussed further below.

The first to fourth switches 51 to 54 form an H-bridge bridge circuit that may be used to apply pulses to the resonant circuit 56, with the first and second switches 51 and 52 forming a first half-bridge, and the third and fourth switches 53 and 54 forming a second half-bridge. Thus the first to fourth switches 51 to 54 are an example implementation of the switching arrangement 13 and the resonant circuit 56 is an example of the resonant circuit 14.

The first and second switches 51 and 52 form a first limb of the full H-bridge circuit and the third and fourth switches 53 and 54 form a second limb. More specifically, the first switch 51 can selectively provide a connection between a first power source (labelled VDD in FIG. 5) and a first connection point, the second switch 52 can selectively provide a connection between the first connection point and ground, the third switch 53 can selectively provide a connection between the first power source and a second connection point and the fourth switch 54 can selectively provide a connection between the second connection point and ground. The resonant circuit 56 is provided between the first and second connection points.

FIG. 6 is a block diagram of a circuit, indicated generally by the reference numeral 60, in accordance with an example embodiment. The circuit 60 is an example implementation of the circuit 50 described above.

The circuit 60 comprises a positive terminal 67 and a negative (ground) terminal 68 (that are an example implementation of the DC voltage supply 11 of the system 10 described above). The circuit 60 comprises a switching arrangement 64 (implementing the switching arrangement 13 described above), where the switching arrangement 64 comprises a bridge circuit (e.g. an H-bridge circuit, such as an FET H-bridge circuit). The switching arrangement 64 comprises a first limb 64a and a second limb 64b, where the first limb 64a and the second limb 64b are coupled by a resonant circuit 69 (which resonant circuit implements the resonant circuits 14 and 56 described above). The first limb 64a comprises switches 65a and 65b (implementing the switches 51 and 52 described above), and the second limb 64b comprises switches 65c and 65d (implementing the switches 53 and 54 described above). The switches 65a, 65b, 65c, and 65d may be transistors, such as field-effect transistors (FETs), and may receive inputs from a controller, such as the control circuit 18 of the system 10.

The resonant circuit 69 comprises a capacitor 66 and an inductive element 63 such that the resonant circuit 69 may be an LC resonant circuit (but may, in practice, be an RLC resonant circuit). The circuit 60 further shows a susceptor equivalent circuit 62 (e.g. representing the susceptor arrangement 16 of the system 10 described above). The susceptor equivalent circuit 62 comprises a resistance and an inductive element that indicate the electrical effect of an example susceptor arrangement (such as the susceptor 16). When a susceptor is present, the susceptor arrangement 62 and the inductive element 63 may act as a transformer 61. Transformer 61 may produce a varying magnetic field such that the susceptor is heated when the circuit 60 receives power. During a heating mode of operation (e.g. during the operation 22 of the algorithm 20), in which the susceptor arrangement 16 is heated by the inductive arrangement, the switching arrangement 64 is driven (e.g., by control circuit 18) such that each of the first and second branches are coupled in turn such that an alternating current is passed through the resonant circuit 69. The resonant circuit 69 will have a resonant frequency, which is based in part on the susceptor arrangement 16, and the control circuit 18 may be configured to control the switching arrangement 64 to switch at the resonant frequency or a frequency close to the resonant frequency. Driving the switching circuit at or close to resonance helps improve efficiency and reduces the energy being lost to the switching elements (which causes unnecessary heating of the switching elements). In an example in which an article comprises an aluminium foil is to be heated, the switching arrangement 64 may be driven at a frequency of around 2.5 MHz. However, in other implementations, the frequency may, for example, be anywhere between 500 kHz to 4 MHz, or any other frequency range.

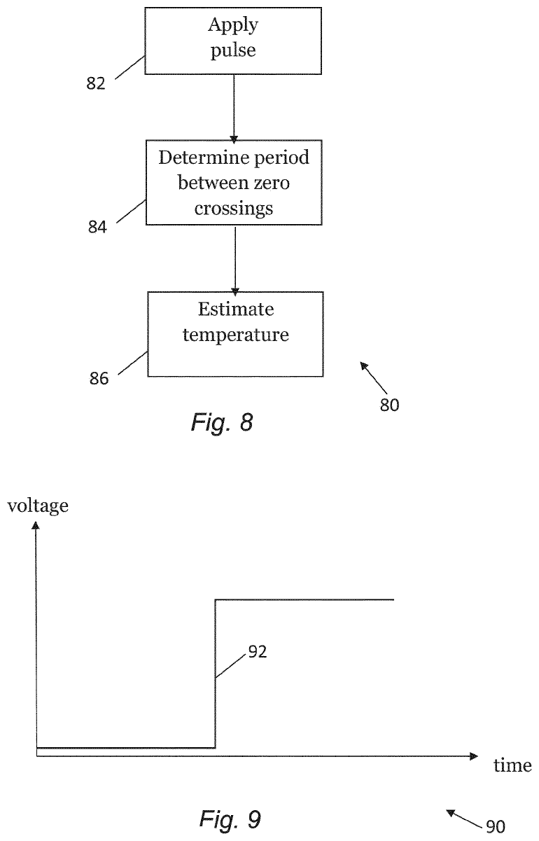

FIG. 7 is a block diagram of a system, indicated generally by the reference numeral 70, in accordance with an example embodiment.

The system 70 comprises a pulse generation circuit 72, a resonant circuit 74 (such as the resonant circuits 14, 56 and 69), a susceptor 76 (such as the susceptor arrangement 16) and a pulse response processor 78. The pulse generation circuit 72 and the pulse response processor 74 may be implemented as part of the control circuit 18 of the system 10 and may be used during the sampling mode 26 of the algorithm 20. Indeed, the pulse generation circuit 72 and the pulse response processor 74 may collectively form a controller for an inductive heater for heating a susceptor in accordance with the principles described herein.

The pulse generation circuit 72 may be implemented using the switching arrangements of the circuits 50 and 60 described above in order to generate a pulse (e.g. pulse edges) by switching between positive and negative voltage sources. This is not essential to all example embodiments; for example, the pulse generation circuit 72 may be implemented using a half-bridge circuit.

The pulse response processor 78 may determine one or more performance metrics (or characteristics) of the resonant circuit 74 and the susceptor 76 based on the pulse response. For example, the pulse response processor 78 may generate an estimate of the temperature of the susceptor 76 and/or a resonant frequency of the resonant circuit.

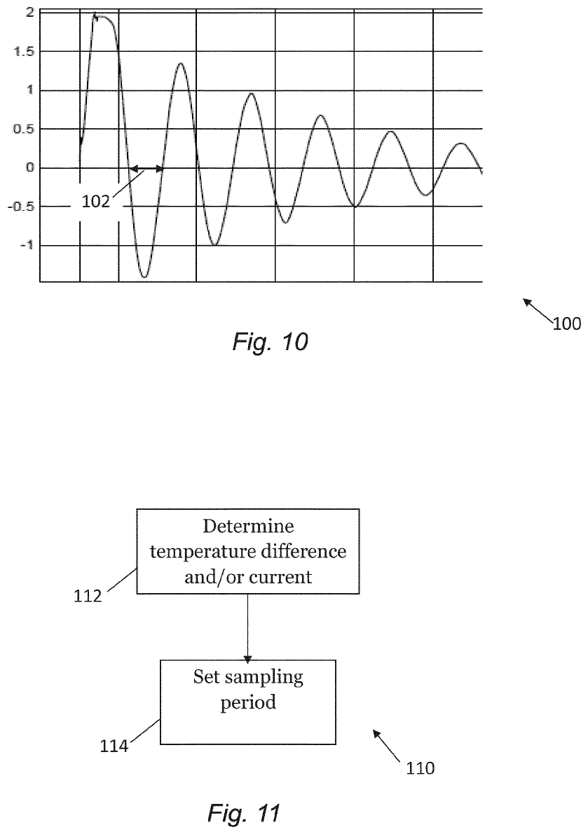

FIG. 8 is a flow chart showing an algorithm, indicated generally by the reference numeral 80, in accordance with an example embodiment. The algorithm 80 shows an example use of the system 70.

The algorithm 80 starts at operation 82 where a pulse is applied to the resonant circuit 74. The pulse is a rising or falling edge generated by the pulse generation circuit 72.

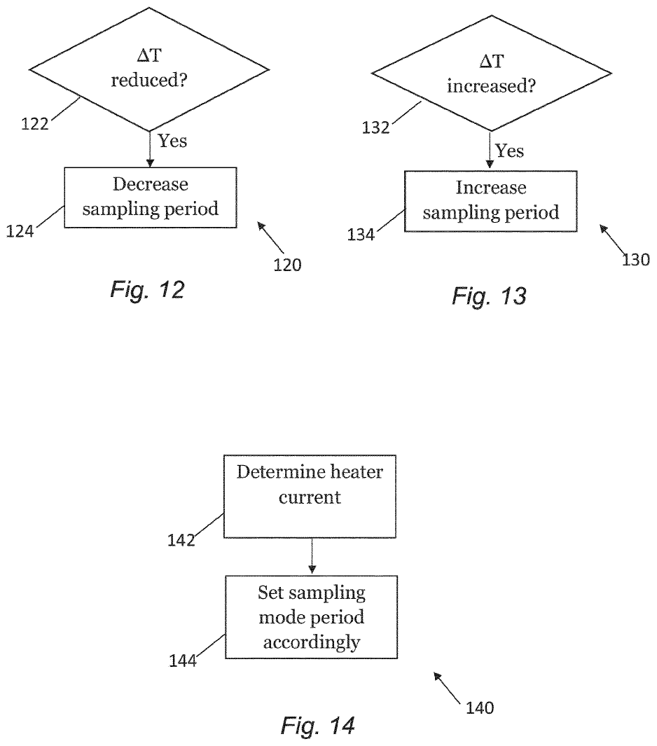

FIG. 9 is a plot showing a pulse 90 in accordance with an example embodiment. The pulse 90 is includes a rising pulse edge 92 that is an example of a pulse edge that may be applied in the operation 82. The pulse 90 may be generated by the pulse generation circuit 72 (e.g. by an H-bridge or half-bridge circuit). The pulse 90 may, for example, be applied during the sampling mode 24 of the algorithm 20 (e.g. to generate a pulse response for use in estimating temperature and/or resonant frequency).

The pulse 90 may be applied to the resonant circuit 74. Alternatively, in systems having multiple inductive elements, the pulse generation circuit 72 may select one of a plurality of resonant circuits, each resonant circuit comprising an inductive element for inductively heating a susceptor and a capacitor, wherein the applied pulse induces a pulse response between the capacitor and the inductive element of the selected resonant circuit.

The application of the pulse edge 92 to the resonant circuit 74 generates a pulse response.

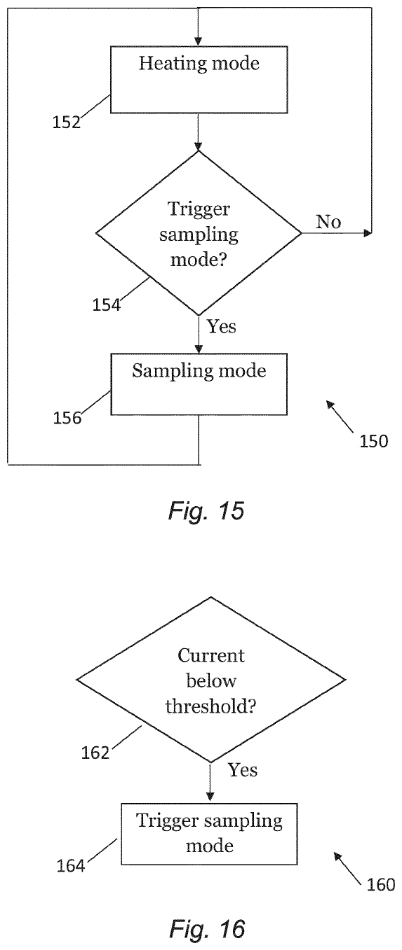

FIG. 10 is a plot, indicated generally by the reference numeral 100, showing an example pulse response that might be generated at a connection point between the capacitor 66 and the inductor 63 of the resonant circuit 69 described above in response to the pulse edge 92. As shown in FIG. 10, the pulse response 100 may take the form of a ringing resonance. The pulse response is a result of charge bouncing between the inductor(s) and capacitor(s) of the resonant circuit. In one arrangement, no heating of the susceptor is caused as a result. That is, the temperature of the susceptor remains substantially constant (e.g., within ±1° C. or ±0.1° C. of the temperature prior to applying the pulse). As shown in FIG. 10, a period 102 between zero-crossings can be used to determine a resonant frequency of the pulse response. Note that in some example embodiments other measurements may be taken, such as the period between successive peaks of the ringing response).

At operation 84 of the algorithm 80, the period between zero crossings (e.g. the period 102) is determined. Then, at operation 86, a temperature estimate is obtained based, at least in part, on the period determined in the operation 84.

The temperature of the resonant circuit may be related to the time period between the zero-crossing 102. For example, temperature may be broadly proportional to that time period. Once calibrated, the time period between zero-crossing can be used for temperature measurement (e.g. for determining a relative temperature) in the operation 86 described above. As noted above, other time periods may be determined in a variant of the operation 84 (such as the time period between successive peaks of the ringing response); this might be appropriate, for example, if the ringing response has a DC component.

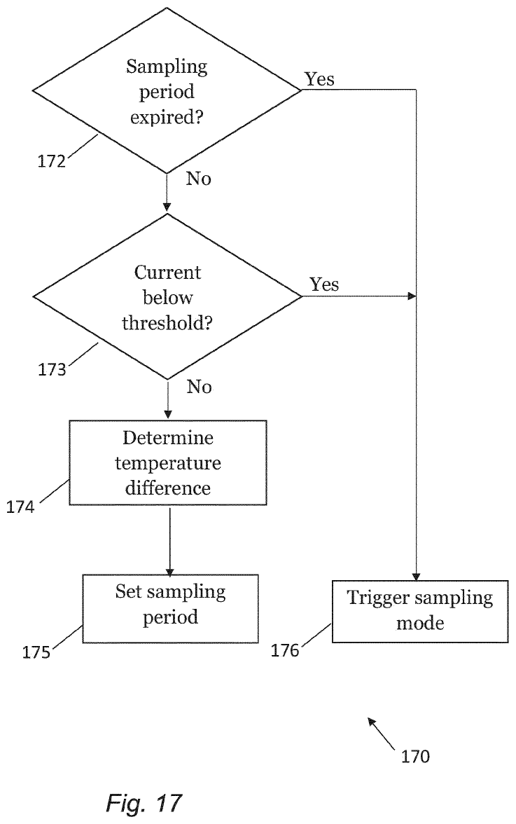

FIG. 11 is a flow chart showing an algorithm, indicated generally by the reference numeral 110, in accordance with an example embodiment.

The algorithm 110 starts at operation 112, where one or more of a temperature measurement (a difference between a temperature of inductive heater and a target temperature of said heater) and a current (e.g. the current flowing in the inductive heater, such as in the resonant circuit 14) are determined or estimated. As discussed above, the relevant temperature may be the temperature of the susceptor (e.g. the susceptor 16 of the system 10 described above). That temperature may, for example, be determined based on a time period between zero-crossing of a pulse response.

At operation 114, a sampling period or frequency based, at least in part, on the output of the operation 112. Thus, the sampling period (or sampling frequency) may be based on a difference between a temperature of an inductive heater and a target temperature, on a detected current level, or both. The sampling period or frequency defines the interval between sampling modes (and therefore defines the duration of heating modes of operation of the inductive heater). The algorithm 110 is therefore an example implementation of the operation 26 of the algorithm 20 described above.

The operation 114 of the algorithm 110 may be implemented in a number of ways. FIGS. 12 to 14 show three example implementations. Note that example embodiments may include two or more of those implementations (and may include further examples not described herein).

FIG. 12 is a flow chart showing an algorithm, indicated generally by the reference numeral 120, in accordance with an example embodiment. The algorithm 120 starts at operation 122, where a determination is made regarding whether a difference between an estimated heater temperature and a target heater temperature (e.g. as determined in the operation 112) is reduced (compared with a previous sample). If so, the sampling period is decreased (or the sampling frequency is increased) at operation 124 of the algorithm 120. Thus, as the heater temperature gets closer to the target temperature, sampling is performed more often.

FIG. 13 is a flow chart showing an algorithm, indicated generally by the reference numeral 130, in accordance with an example embodiment. The algorithm 130 starts at operation 132, where a determination is made regarding whether a difference between an estimated heater temperature and a target heater temperature (e.g. as determined in the operation 112) is increased. If so, the sampling period is increased at operation 134 of the algorithm 130. Thus, as the heater temperature moves away from the target temperature, sampling is performed less often. More specifically, sampling may be performed less often is the heater temperature is below the target temperature and the heater temperature is moving away from the target temperature.

The algorithms 120 and/or 130 may therefore form part of the operation 114 of the algorithm 110 (or the operation 26 of the algorithm 20), such that the sampling period may be increased or decreased dependent on whether the temperature difference determined the operation 112 is increasing or decreasing. In this way, as the temperature approaches the target temperature, the sampling period reduces. Of course, the algorithms 120 and 130 may be implemented as a single algorithm, rather than as two separate algorithms.

By decreasing the sampling period as the determined/estimated temperature approaches the target temperature and increasing the sampling period as the determined/estimated temperature moves away from the target temperature, the ratio between heating time and sampling time can be made higher when the temperature of the heater is well below the target temperature (thereby increasing the proportion of time that the susceptor is being heated) and that ratio can be made lower when the temperature of the heater is close to the target temperature (thereby improving the precision of the heating operation).

FIG. 14 is a flow chart showing an algorithm, indicated generally by the reference numeral 140, in accordance with an example embodiment. The algorithm 140 starts at operation 142, where the current flowing in the heater (for example as determined in the operation 112) is determined. As noted above, a high heater current indicates that the resonant circuit is being driven at, or close to, the resonant frequency. At operation 144, a sampling mode period is set based, at least in part, on the determined heater current. For example, the sampling mode period may be increased as the determined heater current increases and vice-versa (so that sampling is performed less often as the heater current increases).

The algorithm 140 may form part of the operation 114 of the algorithm 110 (or the operation 26 of the algorithm 20). Moreover, the algorithm 120, 130 and 140 (or any combinations thereof) may form part of the operation 114 of the algorithm 110 (or the operation 26 of the algorithm 20).

FIG. 15 is a flow chart showing an algorithm, indicated generally by the reference numeral 150, in accordance with an example embodiment. The algorithm 150 has some similarities with the algorithm 20 described above.

The algorithm 150 starts at operation 152 where a resonant circuit (e.g. the resonant circuit 14) is driven at a determined resonant frequency of the resonant circuit in a heating mode of operation. For example, the switching arrangement 13 may be switched at a determined resonant frequency of the resonant circuit 14 (under the control of the control circuit 18).

At operation 154, a determination is made regarding whether or not a sampling mode has been triggered. If so, the algorithm moves to operation 156; otherwise, the algorithm returns to operation 152. As discussed in detail elsewhere, whether or not the sampling mode is triggered may be dependent, at least in part, on a current flowing in the inductive heater and/or on a temperature of the inductive heater.

At operation 156, a sampling mode of operation is entered. The sampling mode may seek to determine the resonant frequency for use in the heating mode 152. As discussed in detail above, the sampling mode may include applying a pulse to the resonant circuit and processing the resonant response to determine/estimate the resonant frequency (e.g. based on a determined/estimated temperature). For example, the resonant frequency may be determined based on a time-period between zero-crossings of the pulse response. At operation 156, the driving frequency for the resonant circuit is set based on the determined resonant frequency.

On completion of the sampling mode (and following the setting of the driving frequency), the algorithm 150 returns to operation 152, where the heating mode of operation is once again entered.

The operation 154 may include determining whether a sampling mode period has expired. If so, the algorithm 150 moves to operation 156; otherwise the algorithm 150 returns to operation 152. The sampling mode period may, for example, be set as described above with reference to FIGS. 11 to 14.

Alternatively, or in addition, the operation 154 may include determining whether a specific condition (other than the expiry of a sampling mode period) has occurred that warrants the triggering of the sampling mode. Thus, in some example embodiments, a sampling period may be used for routine sampling and, in addition, the sampling mode may be triggered when a defined event (such as a threshold being exceeded) occurs.

FIG. 16 is a flow chart showing an algorithm, indicated generally by the reference numeral 160, in accordance with an example embodiment. The algorithm 160 is an example implementation of the operation 154 of the algorithm 150 described above.

At operation 162 of the algorithm 160, a determination is made regarding whether the current flowing in the heater (for example as determined in the operation 152) is below a threshold level (indicating, for example, that the driving frequency of the heater is not sufficiently close to the resonant frequency). If so, the algorithm moves to operation 164, where the sampling mode is triggered. The operation 164 may therefore trigger the sampling mode 156 of the algorithm 150 described above.

FIG. 17 is a flow chart showing an algorithm, indicated generally by the reference numeral 170, in accordance with an example embodiment. The algorithm 170 is an example implementation of the operation 154 of the algorithm 150 described above.

The algorithm 170 starts at operation 172, where a determination is made regarding whether a sampling period has expired. If so, the algorithm moves to operation 176, where the sampling mode is triggered (e.g. triggering the sampling mode 156 of the algorithm 150 described above). If not, the algorithm moves to operation 173.

At operation 173, a determination is made regarding whether the current flowing in the heater is below a threshold level (indicating, for example, that the driving frequency of the heater is not sufficiently close to the resonant frequency). If so, the algorithm moves to operation 176, where the sampling mode is triggered (e.g. triggering the sampling mode 156 of the algorithm 150 described above). If not, the algorithm moves to operation 174.

At operation 174, a difference between the heater temperature and a target heater temperature is determined. At operation 175, the sampling period is set depending on the difference determined in the operation 174, as discussed in detail above.

Thus, the algorithm 170 provides an example implementation of the operation 154 of the algorithm 150 in which both heater current and heater temperature can be used to determine when and how to trigger the sampling mode.

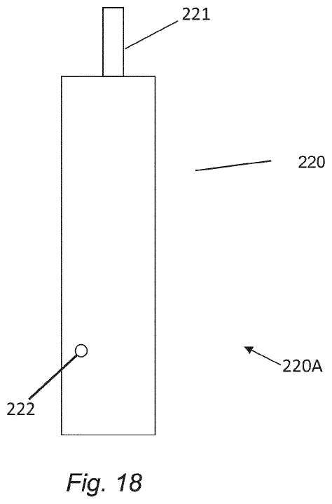

FIGS. 18 to 20 show a non-combustible aerosol provision system indicated generally by the reference numeral 220, in accordance with an example embodiment. The aerosol provision system comprises an aerosol provision device which is an example of an inductively heated device that may be controlled in accordance with the principles described herein.

FIG. 18 is a perspective illustration of an aerosol provision device 220A with an outer cover. The aerosol provision device 220A may comprise a replaceable article 221 that may be inserted in the aerosol provision device 220A to enable heating of a susceptor (which may be comprised within the article 221, as discussed further below). The aerosol provision device 220A may further comprise an activation switch 222 that may be used for switching on or switching off the aerosol provision device 220A.

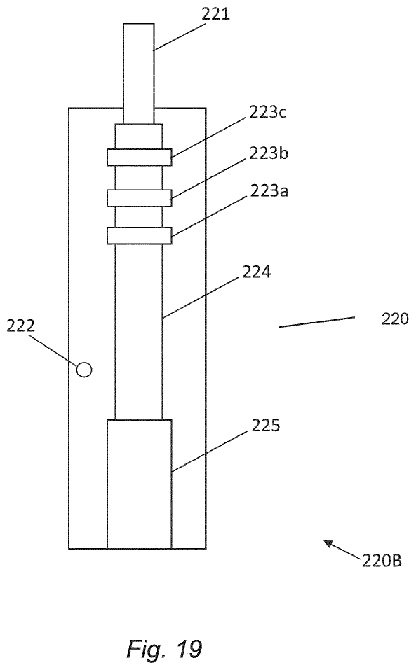

FIG. 19 depicts an aerosol provision device 220B with the outer cover removed. The aerosol generating device 220B comprises the article 221, the activation switch 222, a plurality of inductive elements 223a, 223b, and 223c, and one or more air tube extenders 224 and 225. The one or more air tube extenders 224 and 225 may be optional. The activation switch 222 may be optional; for example a pressure trigger or some other activation-on-demand arrangement may be provided.

The plurality of inductive elements 223a, 223b, and 223c may each form part of a resonant circuit, such as the resonant circuit 14. The inductive element 223a may comprise a helical inductor coil. In one example, the helical inductor coil is made from Litz wire/cable which is wound in a helical fashion to provide the helical inductor coil. Many alternative inductor formations are possible, such as inductors formed within a printed circuit board. The inductive elements 223b and 223c may be similar to the inductive element 223a. The use of three inductive elements 223a, 223b and 223c is not essential to all example embodiments. Thus, the aerosol generating device 220 may comprise one or more inductive elements.

A susceptor may be provided as part of the article 221. In an example embodiment, when the article 221 is inserted in aerosol generating device 220, the aerosol generating device 220 may be turned on due to the insertion of the article 221. This may be due to detecting the presence of the article 221 in the aerosol generating device using an appropriate sensor (e.g., a light sensor) or, in cases where the susceptor forms a part of the article 221, by detecting the presence of the susceptor using the resonant circuit 14, for example. When the aerosol generating device 220 is turned on, the inductive elements 223 may cause the article 221 to be inductively heated through the susceptor. In an alternative embodiment, the susceptor may be provided as part of the aerosol generating device 220 (e.g. as part of a holder for receiving the article 221).

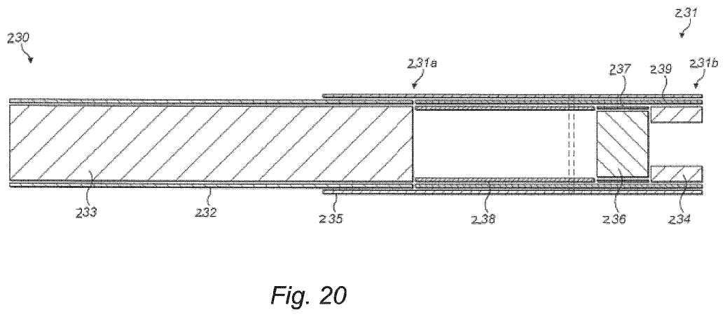

FIG. 20 is a view of an article, indicated generally by the reference numeral 230, for use with a non-combustible aerosol provision device in accordance with an example embodiment. The article 230 is an example of the replaceable article 221 described above with reference to FIGS. 18 and 19.

The article 230 comprises a mouthpiece 231, and a cylindrical rod of aerosol generating material 233, in the present case tobacco material, connected to the mouthpiece 231. The aerosol generating material 233 provides an aerosol when heated, for instance within a non-combustible aerosol generating device, such as the aerosol generating device 20, as described herein. The aerosol generating material 233 is wrapped in a wrapper 232. The wrapper 232 can, for instance, be a paper or paper-backed foil wrapper. The wrapper 232 may be substantially impermeable to air.

In one embodiment, the wrapper 232 comprises aluminium foil. Aluminium foil has been found to be particularly effective at enhancing the formation of aerosol within the aerosol generating material 233. In one example, the aluminium foil has a metal layer having a thickness of about 6 μm. The aluminium foil may have a paper backing. However, in alternative arrangements, the aluminium foil can have other thicknesses, for instance between 4 μm and 16 μm in thickness. The aluminium foil also need not have a paper backing, but could have a backing formed from other materials, for instance to help provide an appropriate tensile strength to the foil, or it could have no backing material. Metallic layers or foils other than aluminium can also be used. Moreover, it is not essential that such metallic layers are provided as part of the article 230; for example, such a metallic layer could be provided as part of the apparatus 220.

The aerosol generating material 233, also referred to herein as an aerosol generating substrate 233, comprises at least one aerosol forming material. In the present example, the aerosol forming material is glycerol. In alternative examples, the aerosol forming material can be another material as described herein or a combination thereof. The aerosol forming material has been found to improve the sensory performance of the article, by helping to transfer compounds such as flavour compounds from the aerosol generating material to the consumer.

As shown in FIG. 20, the mouthpiece 231 of the article 230 comprises an upstream end 231a adjacent to an aerosol generating substrate 233 and a downstream end 231b distal from the aerosol generating substrate 233. The aerosol generating substrate may comprise tobacco, although alternatives are possible.

The mouthpiece 231, in the present example, includes a body of material 236 upstream of a hollow tubular element 234, in this example adjacent to and in an abutting relationship with the hollow tubular element 234. The body of material 236 and hollow tubular element 234 each define a substantially cylindrical overall outer shape and share a common longitudinal axis. The body of material 236 is wrapped in a first plug wrap 237. The first plug wrap 237 may have a basis weight of less than 50 gsm, such as between about 20 gsm and 40 gsm.

In the present example the hollow tubular element 234 is a first hollow tubular element 234 and the mouthpiece includes a second hollow tubular element 238, also referred to as a cooling element, upstream of the first hollow tubular element 234. In the present example, the second hollow tubular element 238 is upstream of, adjacent to and in an abutting relationship with the body of material 236. The body of material 236 and second hollow tubular element 238 each define a substantially cylindrical overall outer shape and share a common longitudinal axis. The second hollow tubular element 238 is formed from a plurality of layers of paper which are parallel wound, with butted seams, to form the tubular element 238. In the present example, first and second paper layers are provided in a two-ply tube, although in other examples 3, 4 or more paper layers can be used forming 3, 4 or more ply tubes. Other constructions can be used, such as spirally wound layers of paper, cardboard tubes, tubes formed using a papier-mâché type process, moulded or extruded plastic tubes or similar. The second hollow tubular element 238 can also be formed using a stiff plug wrap and/or tipping paper as the second plug wrap 239 and/or tipping paper 235 described herein, meaning that a separate tubular element is not required.

The second hollow tubular element 238 is located around and defines an air gap within the mouthpiece 231 which acts as a cooling segment. The air gap provides a chamber through which heated volatilised components generated by the aerosol generating material 233 may flow. The second hollow tubular element 238 is hollow to provide a chamber for aerosol accumulation yet rigid enough to withstand axial compressive forces and bending moments that might arise during manufacture and whilst the article 221 is in use. The second hollow tubular element 238 provides a physical displacement between the aerosol generating material 33 and the body of material 36. The physical displacement provided by the second hollow tubular element 238 will provide a thermal gradient across the length of the second hollow tubular element 238.

Of course, the article 230 is provided by way of example only. The skilled person will be aware of many alternative arrangements of such an article that could be used in the systems described herein. Similarly, the skilled person will be aware of other articles that may be heated using the principles described herein.

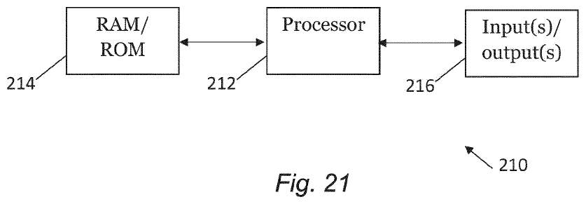

FIG. 21 is a block diagram of a system, indicated generally by the reference numeral 210, in accordance with an example embodiment. The system 210 may be used to implement one or more of the algorithms described above.

The system 210 comprises a processor 212, memory 214 (e.g. RAM or RAM) and may include inputs or outputs 216. The processor 212 may be used to implement one or more of the algorithms described above, for example based on computer program code stored in the memory 214.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A method comprising:
driving a resonant circuit of an inductive heater at a determined resonant frequency of the resonant circuit in a heating mode of operation, wherein the inductive heater comprises a switching circuit and a resonant circuit and wherein the inductive heater is for heating a susceptor;
comparing a current flowing in the inductive heater during the heating mode of operation with a target current; and
controlling triggering of a sampling mode of operation based, at least in part, on a difference between the current flowing in the inductive heater and the target current, wherein the determined resonant frequency is updated during the sampling mode of operation.

2. The method of claim 1, wherein the current flowing in the inductive heater comprises a current flowing in the resonant circuit.

3. The method of claim 1, wherein the current flowing in the inductive heater comprises a current induced in the susceptor.

4. The method of claim 1, wherein controlling triggering of said sampling mode of operation comprises triggering said sampling mode in the event that the current flowing in the inductive heater differs from the target current by more than a threshold amount.

5. The method of claim 1, wherein controlling triggering of said sampling mode of operation comprises setting a sampling period based, at least in part, on the difference between the current flowing in the inductive heater and the target current, wherein the sampling period defines an interval between successive sampling modes of operation of the inductive heater.

6. The method of claim 5, further comprising:
decreasing the sampling mode period if the current flowing in the inductive heater is reduced; and/or
increasing the sampling mode period if the current flowing in the inductive heater is increased.

7. The method of claim 1, further comprising:
entering the heating mode of operation on completion of the sampling mode of operation.

8. The method of claim 1, further comprising:
controlling the switching circuit to apply a pulse to the resonant circuit in the sampling mode of operation to generate a pulse response.

9. The method of claim 1, further comprising:
determining a resonant frequency of the pulse response and updating said determined resonant frequency accordingly.

10. (canceled)

11. The method of claim 1, further comprising:
determining a difference between a temperature of said susceptor and a target temperature of said susceptor and setting a/the sampling period based, at least in part, on said difference, wherein the sampling period defines an interval between successive sampling modes of operation of the inductive heater.

12. The method of claim 11, further comprising decreasing the sampling period if the difference between the estimated temperature and the target temperature is reduced and/or increasing the sampling period if the difference between the estimated temperature and the target temperature is increased.

13. A controller for an inductive heater for heating a susceptor comprising:
a first output for applying pulses to a resonant circuit of the inductive heater in a heating mode of operation, wherein the pulses are applied at a determined resonant frequency of the heater, wherein the inductive heater comprises a switching circuit and a resonant circuit and wherein the inductive heater is for heating a susceptor; and
a control module for controlling triggering of a sampling mode of operation based, at least in part, on a difference between a current flowing in the inductive heater and a target current, wherein a determined resonant frequency of the inductive heater is updated during the sampling mode of operation.

14. The controller of claim 13, wherein the control module triggers said sampling mode of operation in the event that the current flowing in the inductive heater differs from the target current by more than a threshold amount.

15. The controller of claim 13, wherein the control module is configured to set a sampling period based, at least in part, on the difference between the current flowing in the inductive heater and the target current, wherein the sampling period defines an interval between successive sampling modes of operation of the inductive heater.

16. The controller of claim 13, wherein the control module is further configured to determine a difference between a temperature of said susceptor and a target temperature of said susceptor and to set a/the sampling period based, at least in part, on said difference, wherein the sampling period defines an interval between successive sampling modes of operation of the inductive heater.

17. (canceled)

18. An apparatus comprising:
a resonant circuit comprising an inductive element and a capacitor, wherein the inductive element is for inductively heating a susceptor;
a driving circuit for applying pulses to a resonant circuit of the inductive heater in a heating mode of operation, wherein the pulses are applied at a determined resonant frequency of the heater; and
a processor for controlling triggering of a sampling mode of operation based, at least in part, on a difference between a current flowing in the inductive heater and a target current, wherein a determined resonant frequency of the inductive heater is updated during the sampling mode of operation.

19. (canceled)

20. The apparatus of claim 18, wherein the control module is configured to set said sampling period based, at least in part, on the difference between the current flowing in the inductive heater and the target current, wherein the sampling period defines durations an interval between successive sampling modes of operation of the inductive heater.

21. The apparatus of claim 18, wherein the control module is further configured to determine a difference between a temperature of said susceptor and a target temperature of said susceptor and to set a/the sampling period based, at least in part, on said difference, wherein the sampling period defines an interval between successive sampling modes of operation of the inductive heater.

22. (canceled)

23. An aerosol provision device comprising an apparatus of claim 18.

24. An aerosol provision system comprising an aerosol provision device according to claim 23 and an article comprising aerosol generating material.

25. (canceled)
